(19) United States
(12) Patent Application Publication
(10) Pub. No.: US 2018/0167806 A1
(43) Pub. Date: Jun. 14, 2018

(54) DEVICES INCLUDING A PRIVACY SWITCH

(71) Applicant: SILENT CIRCLE SA

(72) Inventor: Aaron Boyd, Draper, UT (US)

(73) Assignee: Silent Circle SA

(21) Appl. No.: 15/373,083

(22) Filed: Dec. 8, 2016

(51) Int. Cl. H04W 12/02

(52) U.S. Cl. CPC H04W 12/02; H04W 88/02

(57) ABSTRACT

Devices including one or more input mechanisms for preventing power from being provided to one or more components of a mobile device are described herein. In some embodiments, a mobile device may include a privacy circuitry that includes a switch, such as a multi-mode switch. The multi-mode switch may be capable of being placed in at least two positions, where one of the positions corresponds to the mobile device being in a privacy mode, and at least one of the positions corresponding to the mobile device being in a non-privacy mode. When the mobile device is in the privacy mode, the mobile device behaves as if a power source for the mobile device had been completely removed, thereby increasing the mobile device's security for preventing external interrupts and penetration.

### BACKGROUND

Mobile devices, such as mobile phones, are becoming more and more ingrained in people's daily lives. Mobile devices can be highly personal devices, such as contact information, emails, telephone numbers, and the like. Reducing and/or eliminating the vulnerability of one's mobile device is paramount to ensure that one's sensitive information remains confidential.

### BRIEF DESCRIPTION OF THE DRAWINGS

FIG. 1 is an illustrative block diagram of an exemplary mobile device, in accordance with various embodiments;

FIGS. 2A and 2B are illustrative front perspective and side perspective views of an exemplary mobile device including an exemplary multi-mode privacy switch, in accordance with various embodiments;

FIGS. 3A and 3B are illustrative side perspective views of an exemplary mobile device including an exemplary privacy toggle switch, in accordance with various embodiments;

FIG. 4 is an illustrative side perspective view of an exemplary mobile device and an exemplary privacy plug, in accordance with various embodiments;

FIGS. 5A-D are illustrative schematic diagrams of an exemplary multi-mode switch capable of placing a mobile device in different operational modes, in accordance with various embodiments;

FIG. 6 is an illustrative schematic diagram of an exemplary system for a mobile device including a privacy circuitry, in accordance with various embodiments; and

FIG. 7 is an illustrative flowchart of an exemplary process for causing a device to exit a privacy mode, in accordance with various embodiments.

### DETAILED DESCRIPTION

The present disclosure, as set forth below, is generally directed to various embodiments of devices including a privacy switch. Mobile devices, such as smart phones, tablets, and/or laptop computers, are extremely personal device that store, or are capable of storing, sensitive information. For example, mobile devices may include contact information for one's personal and professional contacts, global positioning information, banking information, and the like. In the wrong hands, this information can be misused, and even become dangerous.

Mobile devices may be particularly vulnerable to external forces attempting to access information stored by the mobile device and/or control operation and functionality of the mobile device. For example, some external forces are capable of completely controlling ones mobile device remotely by merely obtaining a telephone number or other identifier for the mobile device. These forces are capable of monitoring the activities performed using the mobile device, see incoming and outgoing communications from the mobile device, and access information stored by the mobile device. Even when one's mobile device is powered off, some power still resides in various components of the device, making the device still capable of being penetrated by malicious entities.

One possible way to eliminate these types of threats is to physically remove a power source for the mobile device. For instance, removing a battery from one's phone prior to entering a secure meeting space will prevent an outside entity from being able to listen into the meeting using the phone's microphones. Unfortunately, removing one's battery from one's phone prior to entering a meeting can be inconvenient, as well as difficult to remember at all times. Furthermore, many newer devices do not include removable batteries, making removal of the device's battery not possible. This means that any device including such a non-removable battery is susceptible to malicious external attacks.

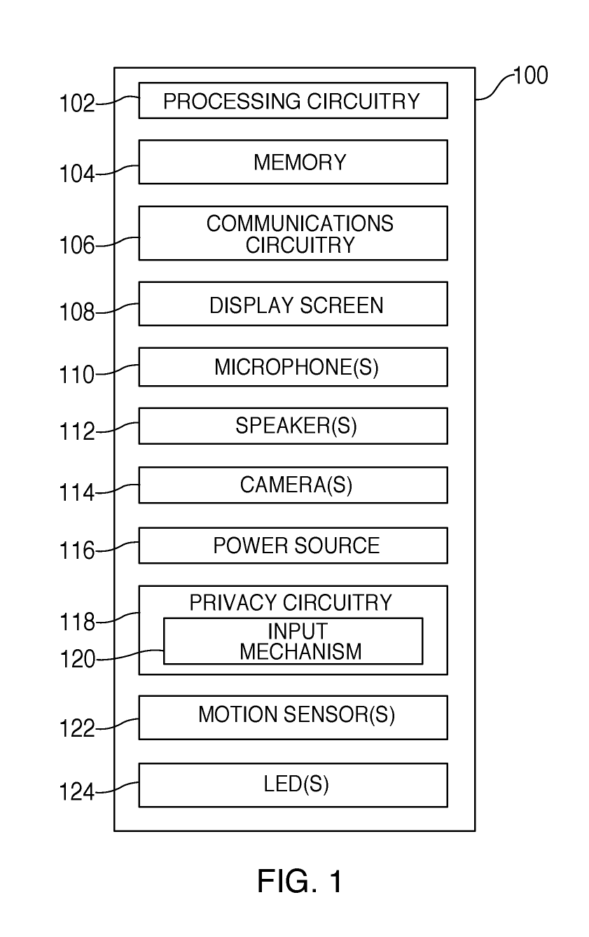

FIG. 1 is an illustrative block diagram of an exemplary mobile device, in accordance with various embodiments. Mobile device 100 may correspond to any type of electronic device including, but not limited to, mobile computers (e.g., laptops, ultrabooks), mobile phones, smart phones, tablets, watches, bracelets, personal digital assistants (“PDAs”), and/or smart accessories. While mobile device 100, in the exemplary embodiment, is described as being any suitable type of “mobile” device, persons of ordinary skill in the art will recognize that other types of electronic devices, such as desktop computers, televisions, smart furniture, and/or smart vehicles, may also be applicable to the foregoing description, and the various embodiments described herein are not to be construed as limiting.

Mobile device 100 may, in some embodiments, include one or more of processing circuitry 102, memory 104, communications circuitry 106, display screen 108, microphone(s) 110, speaker(s) 112, camera(s) 114, power source 116, privacy circuitry 118, motion sensor(s) 122, and light emitting diodes (“LEDs”) 124. In some embodiments, mobile device 100 may include one or more input mechanisms, such as input mechanism 120 included with privacy circuitry 118. However, one or more additional components may be included within mobile device 100, and/or one or more components may be omitted. For example, mobile device 100 may also include a bus connector, a gyroscope, global positioning circuitry, and/or infrared sensors/emitters. Furthermore, while multiple instances of one or more components may be included within mobile device 100, for simplicity only one of each component has been shown.

Processing circuitry 102 may include one or more processors capable of controlling operations and functionality of mobile device 100, as well as facilitating communications between various components within mobile device 100. In some embodiments, processing circuitry 102 may include a central processing unit (“CPU”), a graphic processing unit (“GPU”), one or more microprocessors, a digital signal processor, or any other type of processor, or any combination thereof. In some embodiments, the functionality of processing circuitry 102 may be performed by one or more hardware logic components including, but not limited to, field-programmable gate arrays (“FPGA”), application specific integrated circuits (“ASICs”), application-specific standard products (“ASSPs”), system-on-chip systems (“SOCs”), and/or complex programmable logic devices (“CPLDs”). Furthermore, processing circuitry 102 may include its own local memory, which may store program modules, program data, and/or one or more operating systems. However, processing circuitry 102 may run an operating system (“OS”) for mobile device 100, and/or one or more firmware applications, media applications, and/or applications resident thereon.

Memory 104 may include one or more types of storage mediums such as any volatile or non-volatile memory capable of storing data on mobile device 100. In some embodiments, memory 104 may be removable from mobile device 100, however by making memory 104 removable, mobile device 100 may similar be susceptible to malicious attacks.

Information may be stored by memory 104 using computer-readable instructions, data structures, and/or program modules. Various types of storage/memory may include, but are not limited to, hard drives, solid state drives, flash memory, permanent memory (e.g., ROM), electronically erasable programmable read-only memory (“EEPROM”), CD-ROM, digital versatile disk (“DVD”) or other optical storage medium, magnetic cassettes, magnetic tape, magnetic disk storage or other magnetic storage devices, RAID storage systems, or any other storage type, or any combination thereof. Furthermore, memory 104 may be implemented as computer-readable storage media (“CRSM”), which may be any available physical media accessible by processing circuitry 102 to execute one or more instructions stored within memory 104. In some embodiments, one or more applications (e.g., games, music, video, calendars, lists, etc.) may be run by processing circuitry 102, and may be stored in memory 104.

Communications circuitry 106 may include any circuitry allowing or enabling mobile device 100 to communicate with one or more devices, servers, and/or systems. For example, communications circuitry 106 may facilitate communications between mobile device 100 a remote data storage system. Communications circuitry 106 may use any number of communication protocols. For example, Transfer Control Protocol and Internet Protocol (“TCP/IP”) (e.g., any of the protocols used in each of the TCP/IP layers), Hypertext Transfer Protocol (“HTTP”), and wireless application protocol (“WAP”), are some of the various types of protocols that may be used by mobile device 100 to facilitate communications. In some embodiments, mobile device 100 may communicate with one or more additional devices, servers, and/or systems via a web browser using HTTP. Various additional communication protocols may be used by mobile device 100 to facilitate communications including, but not limited to, Wi-Fi (e.g., 802.11 protocol), Bluetooth, radio frequency systems (e.g., 900 MHz, 1.4 GHz, and 5.6 GHz communication systems), cellular networks (e.g., GSM, AMPS, GPRS, CDMA, EV-DO, EDGE, 3GSM, DECT, IS-136/TDMA, iDen, LTE or any other suitable cellular network protocol), infrared, BitTorrent, FTP, RTP, RTSP, SSH, and/or VOIP, such as any of the previously mentioned exemplary communications protocols. In some embodiments, mobile device 100 may include an antenna to facilitate wireless communications with a network using various wireless technologies (e.g., Wi-Fi, Bluetooth, radiofrequency, etc.). In yet another embodiment, mobile device 100 may include one or more universal serial bus (“USB”) ports, one or more Ethernet or broadband ports, and/or any other type of hardwire access port so that communications circuitry 106 allows mobile device 100 to communicate with one or more communications networks.

Mobile device 100 may include a display screen 108. Display screen 108, in some embodiments, may correspond to a touch screen including capacitive sensing panels capable of recognizing touch inputs thereon. Display screen 108 may be any size and/or shape and may be located at any portion of mobile device 100. Various types of displays may include, but are not limited to, liquid crystal displays (“LCD”), monochrome displays, color graphics adapter (“CGA”) displays, enhanced graphics adapter (“EGA”) displays, variable graphics array (“VGA”) display, touch screens, or any other type of display, or any combination thereof. Still further, a touch screen may, in some embodiments, correspond to a display screen .

Mobile device 100 may also include one or more microphones 110 and/or transducers. Microphone(s) 110 may be any suitable component capable of receiving audio signals. For example, microphone(s) 110 may include one or more sensors for generating electrical signals and circuitry capable of processing the generated electrical signals. In some embodiments, microphone(s) 110 may include multiple microphones capable of detecting various frequency levels. As an illustrative example, mobile device 100 may include multiple microphones (e.g., four, seven, ten, etc.) placed at various positions about mobile device 100 to monitor/capture any audio outputted in the environment where mobile device 100 is located. The various microphones 110 may include some microphones optimized for distant sounds, while some microphones may be optimized for sounds occurring within a close range of mobile device 100.

Mobile device 100 may further include one or more speakers 112. Speaker(s) 112 may correspond to any suitable mechanism for outputting audio signals. For example, speaker(s) 112 may include one or more speaker units, transducers, arrays of speakers, and/or arrays of transducers that may be capable of broadcasting audio signals and or audio content to a surrounding area where mobile device 100 may be located. In some embodiments, mobile device 100 may include one or more audio output ports (e.g., 3.5 mm headphone jack) capable of providing audio to headphones or ear buds. However, in other embodiments, mobile device 100 may include wireless audio capabilities such that audio may be output to one or more wireless speakers 112.

Mobile device 100 may also include one or more cameras 114. Camera(s) 114 may correspond to any suitable image capturing component(s) configured to captured one or more images and/or videos. In some embodiments, mobile device 100 may include multiple cameras located at various positions about mobile device 100. For example, mobile device 100 may include a front-facing camera 114 located on a front side of mobile device 100, as well as a rear-facing camera 114 located on a back side of mobile device 100. Camera(s) 114 may be capable of capturing images and/or videos of various resolutions, such as, but not limited to, 726p, 1080p, and 1080i resolutions. In some embodiments, camera(s) 114 may be external to mobile device 100 such that, in camera(s) 114 capture images/videos, and provide those image/videos to mobile device 100 for viewing and/or processing.

In some embodiments, mobile device 100 may include power source 116. Power source 116 may correspond to any suitable power storing/dissipating component, such as a battery. Power source 116 may, for instance, be a rechargeable battery, capable of storing a predefined amount of energy/voltage, and dissipating some or all of that energy/voltage to one or more components of mobile device 100. While it is in general possible for power source 116 to be removable from mobile device 100, as described above, this may leave mobile device 100 vulnerable to external threats, and therefore in the illustrative embodiment, power source 116 is non-removable.

Mobile device 100 may further include privacy circuitry 118. Privacy circuitry 118 is configured to place mobile device 100 in one of: an “on” or “active” mode, an “off,” “inactive,” or “deactivated” mode, or a “privacy” mode. For instance, mobile device 100, and in one exemplary embodiment, privacy circuitry 118, may include switch 120 capable of causing privacy circuitry 118 to place mobile device in one of the aforementioned modes in response to switch 120 being moved in a particular direction, or to a particular position.

Switch 120, in some embodiments, may correspond to a dual-position switch, a multi-mode switch, a toggle switch, and/or a removable plug. Switch 120 may also be capable of being a digital switch activated in response to a particular mechanical action, such as mobile device 100 being oriented in a particular manner for a particular amount of time, or by a certain physical mechanism being invoked. As an illustrative example, switch 120 may correspond to switch, capable of being placed in one of three positions. For instance, the three different positions may correspond to an “on” mode, an “off” mode, and a “privacy” mode.

In the “on” mode, or “active” mode, mobile device 100 is capable of performing normal operations. For example, in the on mode, mobile device 100 may make/receive telephone calls, send/receive text or SMS messages, and/or access the Internet. Generally speaking, when mobile device 100 is in the “on” or “active” mode, processing circuitry 102 and memory 104 are receiving power from power source 116 such that information may be accessed that is stored by mobile device 100, and functionalities of mobile device 100 may be used.

In the “off” mode, memory 104 may be powered down such that power source 116 is not actively providing power thereto for performing read/write functions. When in the “off” mode, many components of mobile device 100 may be powered down such that they receive a reduced amount of power, or no power, from power source 116. However, in the “off” mode, a real time clock and some digital state machines of mobile device 100 still remain active. The components that still receive power while in the “off” mode are capable of detecting hardware interrupts and transitions of mobile device 100 back to the “on” or “active” mode. For example, some of the interrupts that may still occur when mobile device 100 is in the “off” mode include, but are not limited to, detection of a button click to turn mobile device 100 on, interrupts generated by the real time clock, and a battery charging voltage source being connected to mobile device 100 for charging power source 116.

In “privacy” mode, which may also be referred to as “brick” mode, “black” mode, and/or “silent” mode, mobile device 100 is no longer able to detect any type of interrupt. Generally speaking, when in the privacy mode, mobile device 100 is configured to prevent power source 116 from providing power to at least processing circuitry 102, thereby rendering mobile device 100 non-functional. Mobile device 100 may be rendered non-functional at least temporally, for instance. The amount of time with which functionality of mobile device 100 is prevented may be a few seconds, a few minutes, or the like, and functionality may be restored upon one or more actions occurring (e.g., one or more inputs detected). Furthermore, mobile device 100, in the exemplary embodiment, is not capable of acting on any of such interrupts such that mobile device 100 may be placed into the “on” mode. When placed in “privacy” mode, as described herein, mobile device 100 may be configured such that it behaves as if power source 116 has been removed, or otherwise disconnected, from mobile device 100. To exit out of “privacy” mode, mobile device 100 may, in some embodiments, be switched back to be in one of the “on” mode or the “off” mode, and then rebooted to restart mobile device 100.

Mobile device 100 may also include one or more motion sensor(s) 122. For instance, sensor(s) 122 may correspond to an inertial measurement unit (“IMU”) capable of detecting and measuring an amount of force being applied to mobile device 100. Various types of IMUs include, but are not limited to, accelerometers, gyroscopes, and magnetometers. In some embodiments, sensor(s) 122 may correspond to multi-axis IMUs, capable of measuring motion in multiple directions. For example, mobile device 100 may include one or more three-dimensional accelerometers capable of measuring motion along three different axes. In some embodiments, sensor(s) 122 may correspond to single-direction IMUs, capable of measuring motion along a single axis. In this particular scenario, multiple single-axis IMUs may be included within mobile device 100 for measuring motion along various axes. Persons of ordinary skill in the art will further recognize that any additional or alternative sensor may be employed within mobile device 100, such as one or more force sensors or Hall Effect sensors, and the aforementioned is merely exemplary.

Mobile device 100 may also include one or more light emitting diodes (“LEDs”) 124. LEDs 124 may be placed at any suitable position about mobile device 100, and may be capable of emitting light of any particular color. In some embodiments, LEDs 124 may be configured to output light of a particular color when mobile device 100 is placed in the on mode, while also being configured to output light of another color when placed in the off mode. Furthermore, in some embodiments, one or more LEDs 124 may be included within mobile device 100 such that they output light of a certain color when mobile device 100 is placed in the privacy mode.

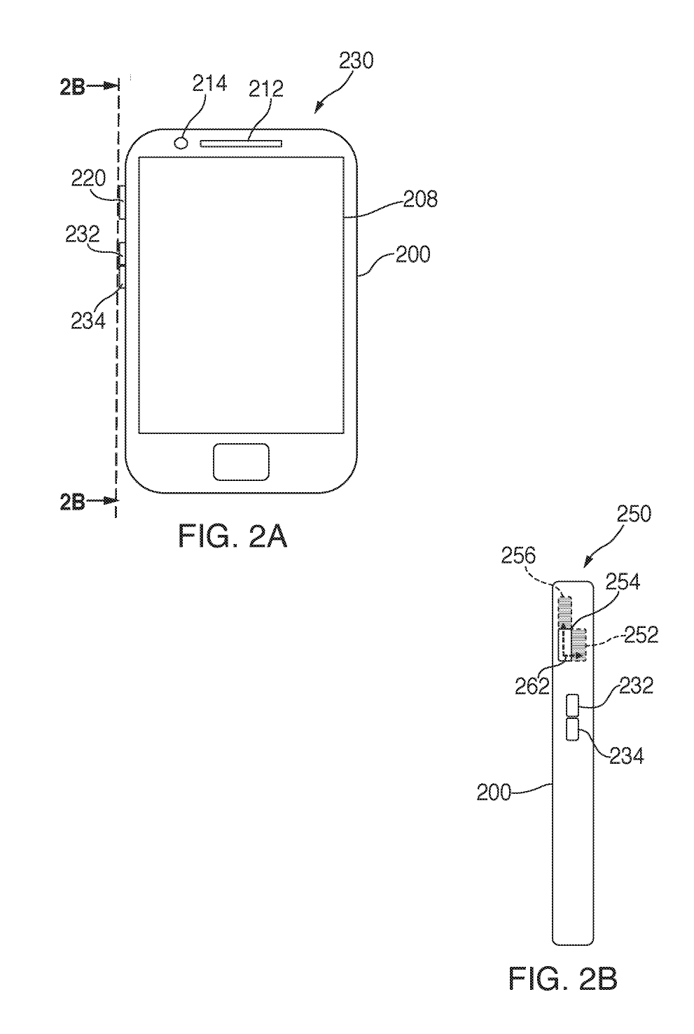

FIGS. 2A and 2B are illustrative front perspective and side perspective views of an exemplary mobile device including an exemplary multi-mode privacy switch, in accordance with various embodiments. In the non-limiting embodiment of FIG. 2A, front perspective view 230 describes mobile device 200, which may be substantially similar to mobile device 100 of FIG. 1, and the previous description may apply. Mobile device 200 may include a display screen 208 located on a front side of mobile device 200. Display screen 208 may occupy a majority of the real estate of the front side of mobile device 200, in the illustrative embodiment. Furthermore, a camera 214 and speaker 212 may also be located on the front side of mobile device 200, adjacent to display screen 208.

Located on a first side of mobile device 200 may be one or more buttons or switches. For instance, in one embodiment, a first button 232 and a second button 234 may be located on the first side. Mobile device 200 may be configured such that buttons 232 and 234 perform any suitable task. As an illustrative example, buttons 232 and 234 may correspond to volume buttons, where button 232 may be configured to cause mobile device 200 to output sounds at a greater volume, while button 234 may be configured to cause mobile device 200 to output sounds at a lesser volume. However, persons of ordinary skill in the art will recognize that buttons 232 and 234 may be configured to perform any suitable action, and the user of buttons 232 and 234 for raising and lowering an audio output level for mobile device 200 is merely exemplary.

In some embodiments, input mechanism 220 may also be located on the first side of mobile device 200, adjacent to buttons 232 and 234. However, in other embodiments, buttons 232 and 234, and input mechanism 220 may be located at different positions about mobile device 200, and they need not be located adjacent to one another.

Input mechanism 220, in the illustrative embodiment, may correspond to a multi-mode switch. For example, as seen from side perspective 250 of FIG. 2B, input mechanism 220 may be capable of being placed in a first position 252, a second position 254 (currently shown), or a third position 256. When input mechanism 220 is placed in first position 252, mobile device 200 may be configured to be in the on mode, whereas when input mechanism 220 is placed in second position 254 or third position 256, mobile device 200 is configured to be in the off mode or privacy mode, respectively. However, persons of ordinary skill in the art will recognize that any of positions 252, 254, or 256 may be associated with any of the on, off, or privacy mode, and the aforementioned is merely exemplary. As input mechanism 220 is capable of causing mobile device 200 to be in one of three (or potentially more) modes based on its positioning, input mechanism 220 may correspond to a multi-mode switch.

To facilitate mobile device 200 switching from one mode to another mode, for instance, an individual operating mobile device 200 may be capable of applying a force to input mechanism 220 to cause input mechanism 220 to move from being in one position (e.g., one of first, second, or third positions 252, 254, or 256) to another position. For instance, in the illustrative embodiment, input mechanism 220 may be in second position 254, corresponding to the off mode. If the individual seeks to cause mobile device 200 to be placed in the on mode, the individual may apply a force to input mechanism 220 that causes input mechanism 220 to move in a first direction, as seen by arrow 262, to place input mechanism 220 in first position 252, corresponding to the on mode. Furthermore, if the individual had wanted to cause mobile device 200 to be placed in the privacy mode, the individual may have alternatively applied a perpendicular force to input mechanism 220 to cause input mechanism 220 to move in a second direction, perpendicular to the first direction, as seen by arrow 264, which would place input mechanism 220 in third position 256 corresponding to the privacy mode.

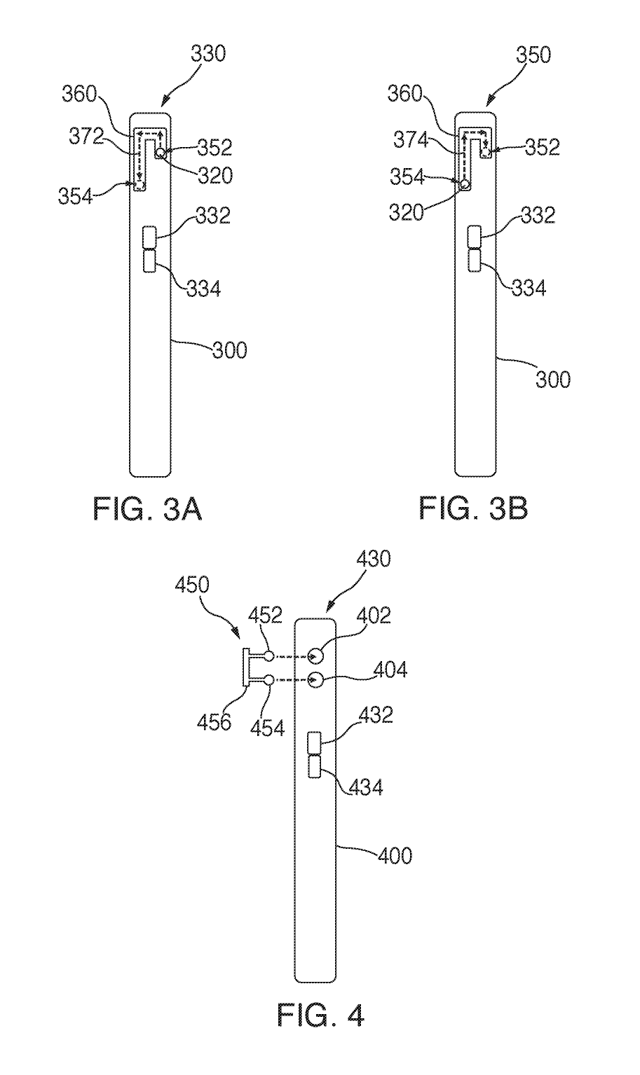

FIGS. 3A and 3B are illustrative side perspective views of an exemplary mobile device including an exemplary privacy toggle switch, in accordance with various embodiments. In the non-limiting embodiment of FIG. 3A, side perspective 330 includes mobile device 300. Mobile device 300, may be substantially similar to mobile device 100 of FIG. 1, and the previous descriptions may apply. Mobile device 300 may, in the illustrative embodiment, include buttons 332 and 334, which may be substantially similar to buttons 232 and 234 of FIGS. 2A and 2B, and the previous descriptions may also apply.

Mobile device 300 further may include, in the non-limiting exemplary embodiment, input mechanism 320. Input mechanism 320, for instance, may correspond to a toggle switch, capable of being placed in a first position 352 or a second position 354. In some embodiments, input mechanism 320 may also be capable of being placed in a third position, or possibly additional positions, however for simplicity only two positions are described.

Input mechanism 320 may be capable of moving from first position 352 to second position 354, and vice versa, through channel 360. In some embodiments, one or more springs or resistive elements may be included within channel 360, or elsewhere about mobile device 300, to provide a resistive force for retaining input mechanism 320 at first position 352 or second position 354. For example, a first spring may apply a first amount of force to input mechanism 320 to retain input mechanism 320 at position 352. In some embodiments, an individual may be required to apply a counter force, or an opposing force, to cause the first spring to release input mechanism 320 from being retained in first position 352 such that input mechanism 320 may be moved to second position 354.

In the illustrative embodiment of FIG. 3A, input mechanism 320 is placed at first position 352. When input mechanism 320 is located at first position 352, mobile device 300 may be configured to be in a first mode. For example, the first mode may correspond to the on or off mode. Generally speaking, in this particular scenario, first position 352 may be associated with any suitable mode for mobile device 300 not corresponding to the privacy mode.

If an individual seeks to place mobile device 300 in the privacy mode, he/she may move input mechanism 320 from first position 352 to second position 354 through channel 360. For example, input mechanism 320 may be moved in a substantially counter-clockwise direction, as shown by arrow 372, to move input mechanism 320 from being in first position 352 to being in second position 354. In the non-limiting embodiment of FIG. 3B, side perspective 350 includes mobile device 300 having input mechanism 320 located at second position 354. In this particular scenario, if an individual seeks to place mobile device 300 in a non-privacy mode (e.g., on mode, off mode), then he/she may move input mechanism 320 from second position 354 to first position 352 through channel 360. For example, input mechanism 320 may be moved in a substantially clockwise direction, as shown by arrow 374, to move input mechanism 320 from being in second position 354 to being in first position 352.

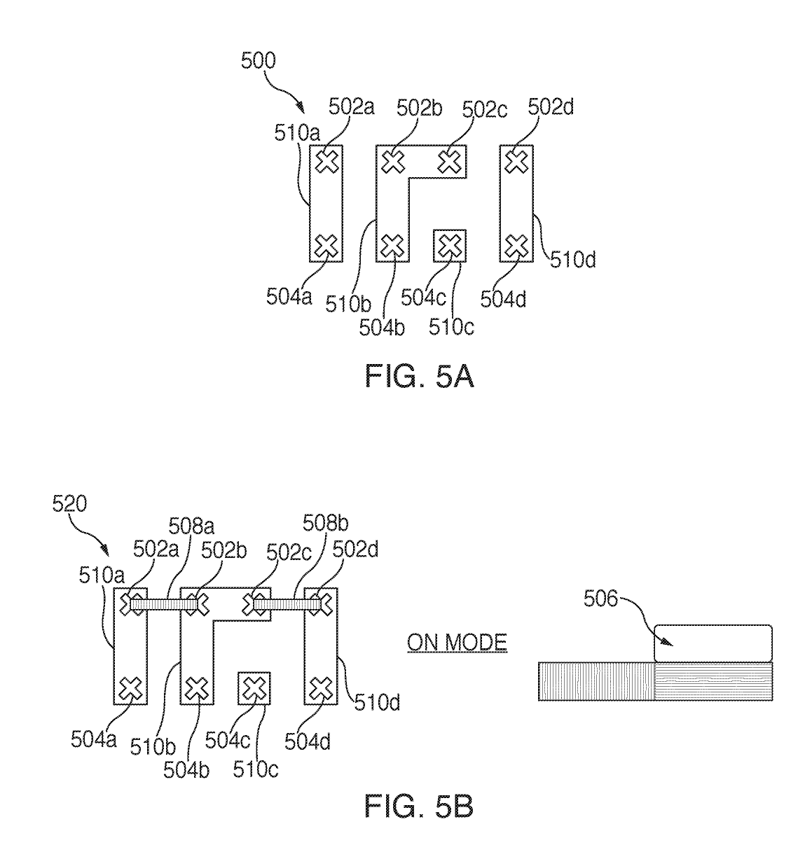

FIG. 4 is an illustrative side perspective view of an exemplary mobile device and an exemplary privacy plug, in accordance with various embodiments. Side perspective view 400 of FIG. 4 includes mobile device 400, which may be substantially similar to mobile device 100 of FIG. 1, and the previous descriptions may apply. Similarly, mobile device 400 may also include buttons 432 and 434, located on the illustrated side of mobile device 400, where buttons 432 and 434 may be substantially similar to buttons 232 and 234 of FIGS. 2A and 2B, and the previous descriptions may apply.

In some embodiments, mobile device 400 may include a first opening 402 and a second opening 404. First opening 402, for instance, may correspond to a reference voltage terminal (e.g., V++), whereas second opening 404 may correspond to a ground terminal. In order to place mobile device 400 in a privacy mode, an external plug 450 may be used to short the reference voltage from ground. External plug 450, in one embodiment, may include a first prong 452 and a second prong 454 coupled together by connector bar 456. First prong 452 and second prong 454 may be formed of an electrically conductive material, such as a metal, while connector bar 456 may be formed of an electrically non-conductive material, such as a plastic. By forming connector bar 456 from a non-conductive material, and individual may easily insert/remove external plug 450 from mobile device 400 without causing any current from flowing through connector bar 456, thereby risking injury to the individual. However, persons of ordinary skill in the art will recognize that first prong 452, second prong 454, and connector bar 456 may be formed of any suitable material(s), and the aforementioned are merely exemplary.

In the illustrative embodiment, first prong 452 and second prong 454 are configured to be inserted within first opening 402 and second opening 404, respectively. Upon insertion, first prong 452 and second prong 454 may disrupt the flow of current from the reference voltage terminal to the ground terminal, thereby removing power from one or more components of mobile device 400. For example, upon inserting first prong 452 and second prong 454 into first opening 402 and second opening 404, respectively, external plug 450 may cause power source 116 to no longer provide power to at least processing circuit 102, thereby preventing mobile device 400 from being able to perform one or more functionalities. Thus, if an individual operating mobile device 400 seeks to place mobile device 400 in the privacy mode, that individual may do so by inserting external plug 450 into mobile device 400, thereby removing power from one or more operating components of mobile device 400.

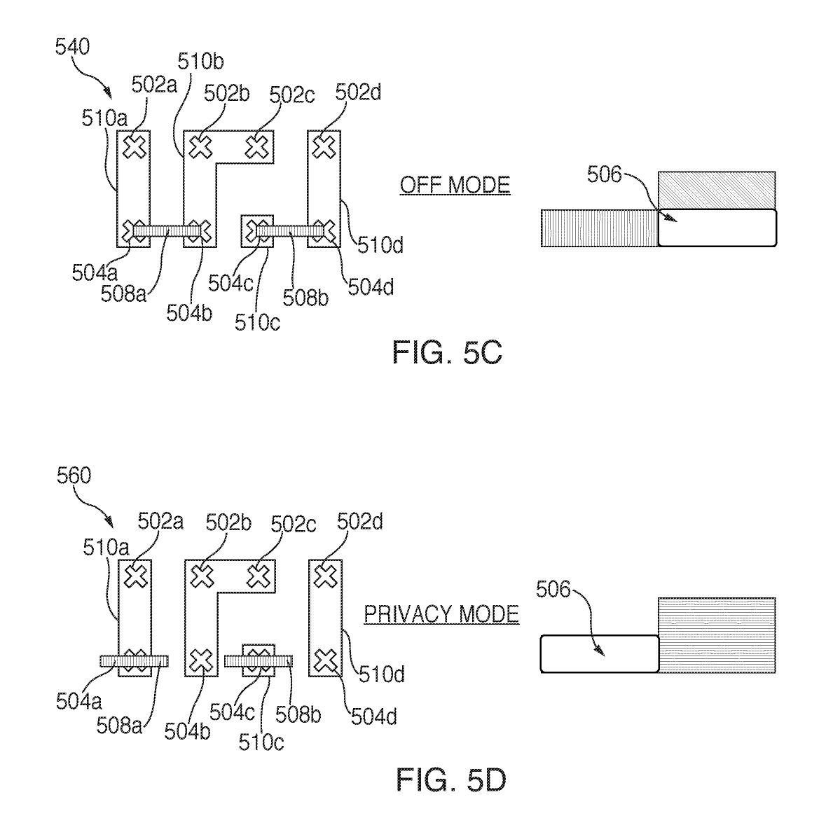

FIGS. 5A-D are illustrative schematic diagrams of an exemplary multi-mode switch capable of placing a mobile device in different operational modes, in accordance with various embodiments. FIG. 5A includes a schematic illustration of a first and second set of electrical contacts for a multi-mode switch, in accordance with various embodiments. FIGS. 5B-5D each include a schematic illustration of a corresponding interaction between one of the sets of electrical contacts of FIG. 5A for the multi-mode switch and electrical contacts of an input mechanism, in accordance with various embodiments.

Switch 500 of FIG. 5A, in the non-limiting embodiment, includes a first set of contacts 502a-d and a second set of contacts 504a-d arranged on switch portions 510a-d. For instance, contacts 502a and 504a may be located on opposite sides of switch portion 510a. Contacts 502b and 502c may both be located on a first side of switch portion 510b, with contact 504b located on a second side of switch portion 510b. Contact 504c may be located on switch portion 510c, and contacts 502d and 504d may be located on opposite sides of switch portion 510d. Persons of ordinary skill in the art will recognize that the illustrated configuration of contacts 502a-d and 504a-d is merely exemplary, and any suitable configuration may be used.

FIG. 5B is an illustrative schematic diagram of a multi-mode switch and input mechanism in an on mode 520, in accordance with various embodiments. In on mode 520, input mechanism 506 may be placed in a first position relative to first set of contacts 502a-d and second set of contacts 504a-d such that contact bars 508a and 508b are in electrical communication with contacts 502a, 502b, and 502c, 502d, respectively. For instance, first contact bar 508a of input mechanism 506, when in on mode 520, resides substantially on top of contacts 502a and 502b, such that contact 502a and contact 502b are in electrical communication with one another. Similarly, second contact bar 508b of input mechanism 506 may reside substantially on top of contacts 502c and 502d such that contact 502c and 502b are in electrical communication with one another. In some embodiments, portion 510b may be associated with a power source for a mobile device. Therefore, when input mechanism 506 is placed in the first position, power (e.g., in the form of an electrical current) may flow from portion 510b to portion 510a via contact bar 508a, and from portion 510b to portion 510d via contact bar 508b. In this particular scenario, portion 510a may be associated with one or more components of mobile device 100, for instance, such as processing circuit 102, whereas portion 510d may be associated with another component, such as a sense circuit. Therefore, when input mechanism 506 is positioned such that mobile device 100 is in the on mode, power is capable of flowing to processing circuit 102 and any other component associated therewith.

FIG. 5C is another illustrative schematic diagram of a multi-mode switch and input mechanism in an off mode 540, in accordance with various embodiments. In off mode 540, input mechanism 506 may be placed in a second position relative to first set of contacts 502a-d and second set of contacts 504a-d such that contact bars 508a and 508b are in electrical communication with contacts 504a, 504b, and 504c, 504d, respectively. For instance, first contact bar 508a of input mechanism 506, when in off mode 540, resides substantially on top of contacts 504a and 504b, such that contact 504a and contact 504b are in electrical communication with one another. Similarly, second contact bar 508b of input mechanism 506 may reside substantially on top of contacts 504c and 504d such that contact 504c and 504d are in electrical communication with one another. As mentioned previously, in some embodiments portion 510b may be associated with a power source for a mobile device. Therefore, when input mechanism 506 is placed in the first position, power (e.g., in the form of an electrical current) may flow from portion 510b to portion 510a via contact bar 508a, and from portion 510b to portion 510c via contact bar 508b. In one embodiment, portion 510c may be associated with a ground source such that when another electrical contact is in electrical communication with the ground source, the electrical connection is shorted to ground (e.g., 0 Volts). Therefore, when input mechanism 506 is positioned such that mobile device 100 is in the off mode, power is disrupted from being provided to any component associated with portion 510d, however components associated with portion 510a may still receive power from portion 510b.

FIG. 5D is yet another illustrative schematic diagram of a multi-mode switch and input mechanism in a privacy mode 560, in accordance with various embodiments. In privacy 560, contact bars 508a and 508b of input mechanism 506 are no longer in electrical communication with any contacts of the first set of contacts 502a-d or the second set of contacts 504a-d. Therefore, power from portion 510b may not be capable of reaching processing circuitry 102, or any other components of the mobile device. This may ensure that the mobile device is not capable of detecting any interrupt, such as from an external threat attempting to access one or more functionalities of the mobile device.

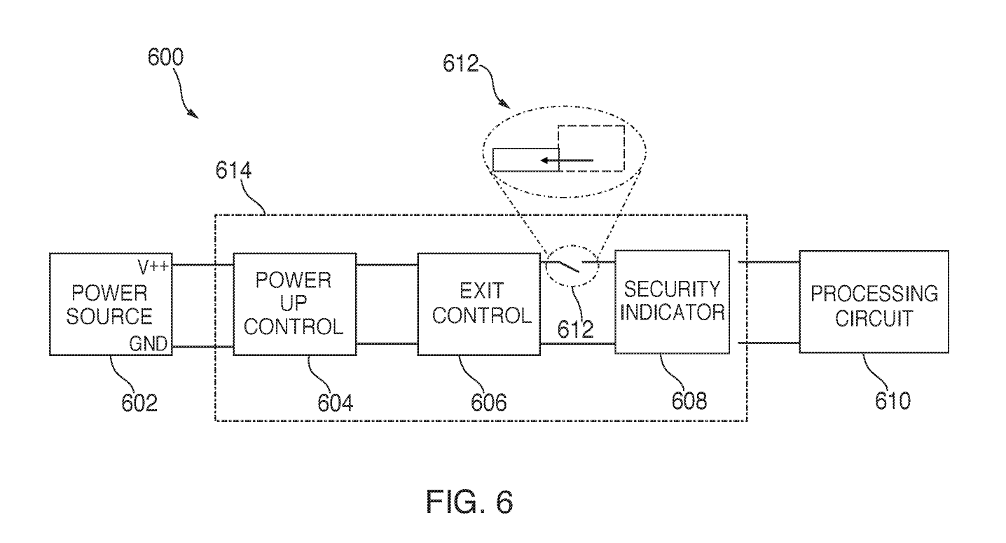

FIG. 6 is an illustrative schematic diagram of an exemplary system for a mobile device including a privacy circuitry, in accordance with various embodiments. System 600, in one embodiment, be implemented within any suitable portion of a device, such as mobile device 100 of FIG. 1. However, in some embodiments, some portions of system 600 may reside within a single component of a device, across multiple components of the device, or located external to the device.

In a non-limiting embodiment, system 600 may include a power source 602 that is in electrical communication with processing circuitry 610 via a privacy circuitry 614. Power source 602, privacy circuitry 614, and processing circuitry 610, for example, may be substantially similar to power source 116, privacy circuitry 118, and processing circuitry 102 of FIG. 1, and the previous description may apply. In the illustrative embodiment, power source 602 may include at least two terminals: one having reference voltage V++ (e.g., a non-zero voltage), and the other being ground (e.g., zero voltage). This allows power source 602 to output an electrical current to privacy circuitry 614 and processing circuit 610 having a magnitude equal to the reference voltage V++ divided by the inherent resistance of the remaining components.

Privacy circuitry 614 may include an electrical switch 612. Electrical switch 612, for instance, may correspond to input mechanism 120 of FIG. 1, and the previous descriptions may apply. Switch 612 may be structured to be “open” or “closed.” When switch 612 is open, for instance, power may be capable of being transmitted through privacy circuitry 614 from power source 602. In particular, power (e.g., current) may flow from power source 602 to processing circuit 610. When switch 612 is closed, power may not be capable of flowing from through privacy circuitry 614, and therefore no current may reach processing circuit 610. In this particular scenario, processing circuit 610 may not be capable of functioning, as no power may currently be flowing into processing circuit 610 from power source 602.

In some embodiments, switch 612 may be opened or closed based on a positioning of an input mechanism, such as input mechanism 506 of FIG. 5. When input mechanism 120, for instance, is placed in a first position, switch 612 may be closed. For example, when in the closed position, input mechanism 506 may correspond to on mode 520 or off mode 540 of FIGS. 5B and 5C. As another example, when in the open position, input mechanism 506 may correspond to privacy mode 560 of FIG. 5D. For instance, switch 612 being closed may allow current to flow across electrical contacts 502a-d or 504a-d, whereas switch 612 being opened may prevent current from flowing across electrical contacts 502a-d or 504a-d.

In some embodiments, privacy circuitry 614 may include a power up control component 604, an exit control component 606, and a security indicator 608. Power up control component 604 may function to ensure that a state latch of the corresponding mobile device is set when power source 602 is charged, or being charged. In some embodiments, power up control component 604 may include a simple mono-stable multi-vibrator to facilitate the state latch setting.

Exit control circuit 606 may be configured to de bounce the output of switch 612 when exiting a privacy mode. Exit control circuit 606 may generate a signal that sets the state latch described above, thereby closing switch 612 to allow power to flow again through privacy circuitry 614 to processing circuit 610 from power source 602.

Power security light 608, in one embodiment, may correspond to an LED, such as LED 124 of FIG. 1, capable of signaling the presence of power reaching processing circuit 610. Therefore, when privacy circuitry 614 is closed, such that power is being received by processing circuit 610 from power source 602, power security light 608 may be capable outputting a particular visual indication (e.g., a blinking light) indicating to an individual a current mode of the corresponding mobile device.

In some embodiments, the exit from privacy mode may be associated with, along with placement of input mechanism 120 in a particular position, a detected mechanical event to cause the corresponding device to reboot. For example, after placing input mechanism 120 in an appropriate position to no longer be in the privacy mode (and thereby closing switch 612), an individual may be required to press down on a particular button or buttons of mobile device 100 for a predefined period of time, thereby restarting mobile device 100 such that power source 116 may begin providing power to one or more components of mobile device 100. As another example, an individual may change an orientation of mobile device 100 (e.g., holding mobile device upside down for a predefined period of time), thereby indicating that mobile device 100 is to restart.

In some embodiments, system 600 (and therefore mobile device 100) may further include a watch crystal and an oscillator configured oscillate at a predefined frequency (e.g., 32 kHz). This would cause a state machine of the mobile device to implement power control 604, exit control 606, and after division, a signal to drive power security light 608.

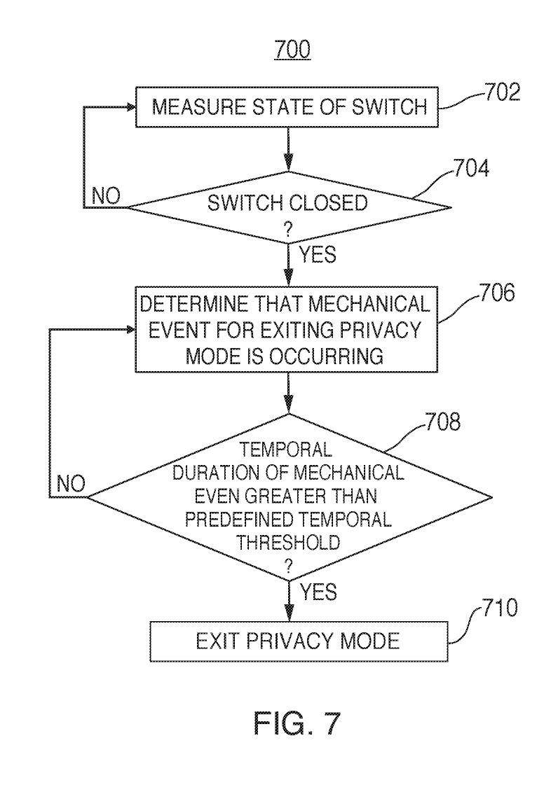

FIG. 7 is an illustrative flowchart of an exemplary process for causing a device to exit a privacy mode, in accordance with various embodiments. Process 700, in the non-limiting embodiment, may begin at step 702. At step 702, a state of a switch associated with a privacy circuitry for a mobile device may be measured. In some embodiments, a mobile device (e.g., mobile device 100) may include a state machine capable of measuring a state of a privacy circuitry (e.g., privacy circuitry 614 of FIG. 6 or privacy circuitry 118 of FIG. 1) at predefined temporal intervals. For example, the state machine may measure a state of a switch (e.g., switch 612) of the mobile device, where the measurements are driven by a 32 kHz watch clock such that measurements may be taken approximately every 31 microseconds.

At step 704, a determination may be made as to whether or not the switch is closed. For example, if switch 612 is closed, then power may be able to flow from power source 602 to processing circuit 610 (as well as any other additional components). Therefore, if the measurement of step 702 indicates that the switch is closed, process 700 may proceed to step 706. However, if at step 702, the measurement indicates that the switch is open, then process 700 may return to step 702, where measurements may continue to be taken approximately every 31 microseconds so that the state of the switch may continually be monitored.

At step 706, a mechanical event associated with exiting a privacy mode for the mobile device may be determined to be occurring. Various types of mechanical events may include, but are not limited to, one or more buttons of the mobile device being pressed, an additional switch being switched, and/or one or more sensors detecting a particular event. As an illustrative example, the mechanical event may correspond to an individual pressing a particular button on the mobile device, such a power button. As another illustrative example, the mechanical event may correspond to the mobile device being turned upside down, such that one or more IMUs included within the mobile device determine that the mobile device is aligned with gravity where a front side of the mobile device is pointed downward.

At step 708, a determination may be made as to whether or not a temporal duration of the mechanical event is greater than a predefined temporal threshold. For example, if the mechanical event is a button being pressed, then at step 708, a determination may be made as to whether the button has been pressed for a certain amount of time. As another example, if the mechanical event is determining that the mobile device is turned upside down, at step 708 the determination may then correspond to determining whether the mobile device has been oriented upside down for a certain amount of time. If so, then that may indicate that the mobile device is to be rebooted such that power source 116 may begin providing power to one or more components (e.g., processing circuit 102).

If, at step 708, it is determined that the temporal duration of the mechanical event is greater than the predefined temporal threshold, then process 700 may proceed to step 710. At step 710, privacy circuitry 118 may cause the mobile device to exit the privacy mode, and enter into the on mode or the off mode, depending on the particular configuration (e.g., depending on a positioning of input mechanism 120).

However, if at step 708, it is determined that the temporal duration is less than or equal to the predefined temporal duration, then process 700 may return to step 706. In this particular scenario, another determination may be made as to whether or not the mechanical event is still occurring. If so, then process 700 may then return to step 708 to see if the temporal duration now exceeds the predefined temporal threshold. However, if the mechanical event is no longer occurring, then process 700 may end. Persons of ordinary skill in the art will recognize that any suitable amount of time may be used for the predefined temporal duration. For example, the predefined temporal duration may be a few seconds, a few minutes, or even hours. Furthermore, persons of ordinary skill in the art will recognize that although, at step 708, the determination is made as to whether or not the temporal duration is greater than the predefined temporal threshold, this is merely exemplary, and in some embodiments, if the temporal duration equals the predefined temporal threshold, then process 700 may be caused to proceed to step 710.

The various embodiments of the invention may be implemented by software, but may also be implemented in hardware, or in a combination of hardware and software. The invention may also be embodied as computer readable code on a computer readable medium. The computer readable medium may be any data storage device which may thereafter be read by a computer system.

The above described embodiments of the invention are presented for purposes of illustration and are not intended to be limiting. Although the subject matter has been described in language specific to structural feature, it is also understood that the subject matter defined in the appended claims is not necessarily limited to the specific features described. Rather, the specific feature are disclosed as illustrative forms of implementing the claims.

1. A device, comprising:
a power supply;
processing circuitry operable to control functionality of the device; and
privacy circuitry operable to prevent the power supply from providing power to at least the processing circuitry such that the device is rendered incapable of responding to interrupts.

2. The device of claim 1, further comprising:
an input mechanism capable of being placed in one of a first position or a second position.

3. The device of claim 2, wherein the privacy circuitry causes the power supply to:
prevent the power from being provided to at least the processing circuitry in response to being placed in the first position; and
allow the power to be provided to at least the processing circuitry in response to being placed in the second position.

4. The device of claim 3, wherein the input mechanism is further capable of being placed in a third position such that the privacy circuitry further causes the power supply to:
allow limited power to be provided to at least the processing circuitry in response to being placed in the third position.

5. The device of claim 1, further comprising:
a switch configured to be placed in at least a first position that causes the privacy circuitry to prevent the power supply from providing the power to at least the processing circuitry.

6. The device of claim 5, wherein the switch comprises:
a dual-position toggle switch capable of being placed in one of the first position or a second position.

7. The device of claim 5, wherein the switch comprises:
a multi-mode switch capable of being placed in one of the first position, a second position, or a third position.

8. The device of claim 1, further comprising:
at least one electrical port capable of receiving an input device that causes the privacy circuitry to prevent the power supply from providing the power to at least the processing circuitry.

9. The device of claim 1, further comprising:
at least one additional component, wherein the privacy circuitry is further operable to prevent the power supply from providing at least a portion of the power from being provided to the at least one additional component.

10. The device of claim 9, wherein the at least one additional component comprises at least one of:
communications circuitry, geographic positioning circuitry, a display screen, at least one microphone, at least one speaker, at least one camera, at least one motion sensor, and memory.

11. A device, comprising:
a button operable to turn the device on;
a clock;
memory;
at least one power source;
communications circuitry;
processing circuitry; and
at least one input mechanism capable of being placed in a first position such that at least the button, the clock, the memory, communications circuitry, and the processing circuitry are prevented from receiving power from the at least one power source to render the device incapable of responding to interrupts.

12. The device of claim 11, wherein the at least one input mechanism is further capable of being placed in a second position, wherein at least the button, clock, memory, communications circuitry, and the processing circuitry are capable of receiving power from the at least one power source in response to the at least one input mechanism being placed in the second position.

13. The device of claim 11, wherein the at least one input mechanism is further capable of being placed in a second position, wherein at least one of the button, clock, memory, communications circuitry, and the processing circuitry are capable of receiving power from the at least one power source in response to the at least one input mechanism being placed in the second position.

14. The device of claim 11, further comprising:
a status indicator that indicates that the device is in a first mode in response to the at least one input mechanism being in the first position.

15. The device of claim 14, wherein the status indicator comprises a light emitting diode (“LED”), the LED is capable of providing a visual indication that the device is in the first mode.

16. The device of claim 11, wherein the at least one power source comprises a rechargeable battery, the at least one input mechanism being placed in the first position allows the rechargeable battery to be charged while preventing power from being provided to at least the button, clock, memory, communications circuitry, and the processing circuitry.

17. The device of claim 11, wherein the at least one input mechanism comprises one of:
a toggle switch; or
a multi-mode switch.

18. The device of claim 11, wherein the at least one power source is non-removable from the device.

19. The device of claim 11, wherein the at least one input mechanism comprises at least one motion sensor, wherein the first position corresponds to the at least one motion sensor determining that the device is oriented in a first orientation.

20. A device, comprising:
means for providing power;
means for controlling functionalities of the device; and
means for preventing the means for providing power from providing power to at least the means for controlling the functionalities such that the device is rendered incapable of responding to interrupts.
